(19) United States
(12) Patent Application Publication
(10) Pub. No.: US 2025/0182936 A1
(43) Pub. Date: Jun. 5, 2025

(54) GROMMET

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Taku UMEHARA, Mie (JP)

(21) Appl. No.: 18/842,396

(22) PCT Filed: Feb. 28, 2023
(86) PCT No.: PCT/JP2023/007278

§ 371 Date: Aug. 29, 2024

(30) Foreign Application Priority Data
Mar. 1, 2022 (JP) 2022-030835

(51) Int. Cl. H01B 17/58

(52) U.S. Cl. CPC H01B 17/583

(57) ABSTRACT

Provided is a grommet suitable for when allowing an additional electric wire to pass through the grommet. A grommet (10, 10A, 10B) enables electric wires (31, 32) to pass therethrough. The grommet (10, 10A, 10B) comprises a tubular inner tube (12, 12A, 12B) and a tubular outer tube (11) that is provided around the inner tube (12, 12A, 12B) so as to surround the inner tube (12, 12A, 12B). The space between the inner tube (12, 12A, 12B) and the outer tube (11) forms a first path (16) through which the first electric wires (31) of the electric wires (31, 32) can pass. The internal space of the inner tube (12, 12A, 12B) forms a second path (17, 17A, 17B) through which the second electric wires (32) of the electric wires (31, 32) can pass.

### TECHNICAL FIELD

The present disclosure relates to a grommet.

### BACKGROUND

A grommet is used to protect an electric wire by passing the electric wire therethrough. For example, Patent Document 1 discloses a grommet provided with one wire pass-through portion. Patent Document 2 discloses a grommet provided with a plurality of wire insertion holes. Patent Document 3 discloses a grommet in which a resin inner sleeve is fitted to a grommet body. Patent Document 4 discloses a twin-type grommet in which a main wire insertion portion and an auxiliary wire insertion portion are provided in parallel. Patent Document 5 discloses a grommet in which a plurality of divided grommet members are linked. Patent Document 6 discloses a grommet provided with three small-diameter tube portions. Patent Document 7 discloses a grommet in which a wire insertion hole is capable of opening and closing.

### PRIOR ART DOCUMENT

### Patent Document

Patent Document 1: JP 2013-135559 A
Patent Document 2: JP H09-009461 A
Patent Document 3: JP 2002-247737 A
Patent Document 4: JP H07-105775 A
Patent Document 5: JP 2009-290956 A
Patent Document 6: JP 2001-160329 A
Patent Document 7: JP H08-331732 A

### SUMMARY OF THE INVENTION

### Problems to be Solved

There are cases where, after an electric wire has been passed through a grommet, an additional electric wire is passed through the grommet. In this case, if the additional electric wire is inserted into the grommet while pushing aside the previously passed electric wire, a problem arises in that the task cannot be smoothly performed. In addition, if a terminal is crimped to the additional electric wire, for example, the previously passed electric wire may interfere with the terminal and be damaged.

In view of this, the grommets disclosed in Patent Documents 4, 5, and 6 include a plurality of tube portions. For example, the grommet disclosed in Patent Document 4 is provided with two tube portions. If an electric wire is passed through one of the two tube portions and then an additional electric wire is passed through the other tube portion, the previously passed electric wire does not interfere with the passage of the additional electric wire. However, since the two tube portions are provided in parallel, the size of the grommet may be unnecessarily increased.

In view of this, an object of the present disclosure is to provide a grommet that is suitable for passing an additional electric wire through the grommet.

### Means to Solve the Problem

The grommet according to the present disclosure is a grommet through which an electric wire can be passed, including a tubular inner tube, and a tubular outer tube provided around the inner tube so as to surround the inner tube, wherein a space between the inner tube and the outer tube forms a first path through which a first electric wire of the electric wire can be passed, and an internal space of the inner tube forms a second path through which a second wire of the electric wire can be passed.

### Effect of the Invention

According to the present disclosure, it is possible to provide a grommet that is suitable for passing an additional electric wire through the grommet.

### BRIEF DESCRIPTION OF THE DRAWINGS

FIG. 1 is a side view of a grommet according to a first embodiment of the present disclosure.

FIG. 2 is a cross-sectional side view of the grommet.

FIG. 3 is a cross-sectional view taken along line A-A in FIG. 2.

FIG. 4 is a cross-sectional side view of the grommet in which a plurality of first electric wires are passed through a first path.

FIG. 5 is a cross-sectional view taken along line B-B in FIG. 4.

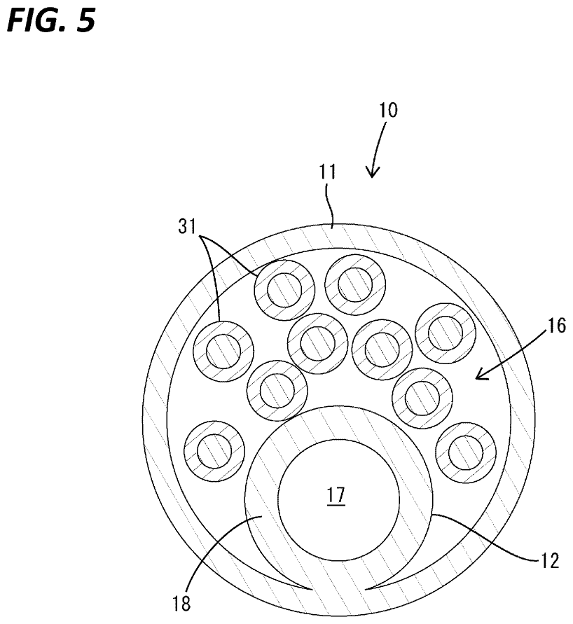

FIG. 6 is a cross-sectional side view showing a state immediately before a second electric wire and a second terminal are passed through a second path.

FIG. 7 is a cross-sectional view of the grommet in which a plurality of the first electric wires are passed through the first path and a plurality of the second electric wires are passed through the second path.

FIG. 8 is a cross-sectional view of the grommet that has deformed so as to stretch in an up-down direction.

FIG. 9 is a cross-sectional view of a grommet according to a second embodiment of the present disclosure.

FIG. 10 is a cross-sectional view of a grommet according to a third embodiment of the present disclosure.

### DETAILED DESCRIPTION TO EXECUTE THE INVENTION

### Description of Embodiments of Present Disclosure

First, embodiments of the present disclosure will be listed and described.
(1) A grommet according to the present disclosure is a grommet through which an electric wire can be passed, including a tubular inner tube, and a tubular outer tube provided around the inner tube so as to surround the inner tube, wherein a space between the inner tube and the outer tube forms a first path through which a first electric wire of the electric wire can be passed, and an internal space of the inner tube forms a second path through which a second wire of the electric wire can be passed.

The first path and the second path are partitioned by the inner tube. Accordingly, after the first electric wire is passed through the first path, the second electric wire can be passed through the second path while avoiding contact with the first electric wire. Accordingly, the task of passing the second electric wire through the grommet can be smoothly performed. In particular, according to the above configuration, since the inner tube is surrounded by the outer tube, the size of the grommet is unlikely to be increased, making it possible for the external appearance of the grommet to be similar to that of an existing grommet.
(2) It is preferable that the inner tube is in contact with and integrally joined to an inner circumferential surface of the outer tube. With this configuration, displacement of the inner tube with respect to the outer tube is avoided, and the state where the electric wires are passed through the grommet can be stably maintained.
(3) It is preferable that the inner tube is formed in a cylindrical shape. With this configuration, it is possible to prevent irregular deformation of the inner tube due to an external force such as a bending force being applied to the grommet.
(4) It is preferable that the outer tube is formed in a cylindrical shape, and a minor arc portion of an outer circumferential surface of the inner tube and a minor arc portion of an inner circumferential surface of the outer tube are integrally joined to each other. With this configuration, it is possible to prevent irregular deformation of the outer tube due to an external force such as a bending force being applied to the grommet. Also, since the minor arc portion of the inner circumferential surface of the outer tube and the minor arc portion of the outer circumferential surface of the inner tube are integrally joined to each other, the wide first path can be ensured between the inner tube and the outer tube.
(5) It is preferable that the outer circumferential surface of the inner tube and the inner circumferential surface of the outer tube are formed continuously without a stepped portion in a circumferential direction. With this configuration, the first path can be efficiently ensured inside the grommet.
(6) It is preferable that the inner tube has rigidity according to which a hollow shape of the second path can be maintained. With this configuration, even when an external force such as a bending force is applied to the grommet, a space through which the second electric wire is passed can be ensured in the second path.
(7) It is preferable that at least one end portion of two end portions in an axial direction of the inner tube protrudes in the axial direction from an opening end of the outer tube. With this configuration, the second electric wire can be easily passed through the second path from one end portion side of the inner tube to the second path with the one end portion of the inner tube as a reference.
(8) It is preferable that the first path has a size that allows a plurality of the first electric wires to be passed through the first path. With this configuration, since the plurality of first electric wires can be passed through the first path, it is excellent in versatility.
(9) It is preferable that the second path has a size that allows a plurality of the second electric wires to be passed through the second path. With this configuration, since the plurality of second electric wires can be passed through the second path, it is excellent in versatility.

### Details of Embodiments of the Present Disclosure

Specific examples of the present disclosure will be described below with reference to the drawings. Note that the present invention is not limited to these examples, but rather is indicated by the scope of the claims, and is intended to include all modifications within the scope and meaning equivalent to the scope of the claims.

### First Embodiment

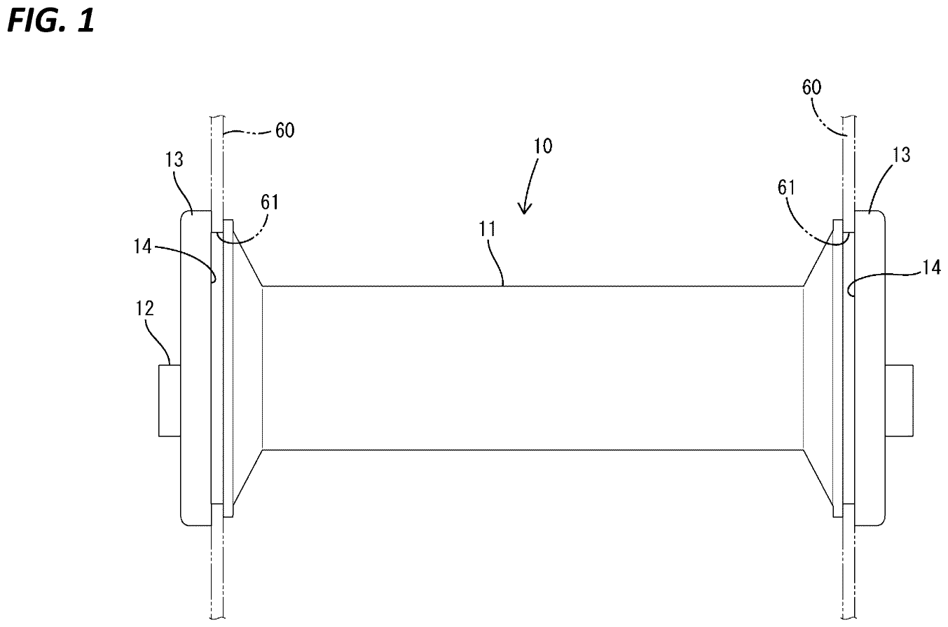

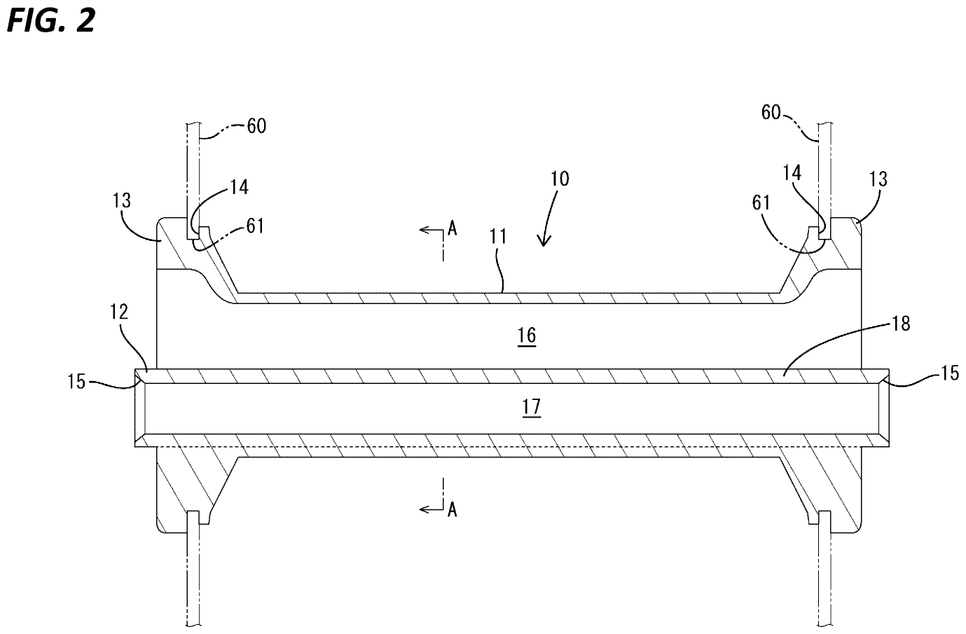

A grommet 10 according to a first embodiment of the present disclosure is integrally formed of rubber or elastomer. As shown in FIGS. 1 and 2, the grommet 10 includes an outer tube 11 having a tubular (specifically cylindrical) shape extending in the axial direction (left-right direction in FIGS. 1 and 2), and an inner tube 12 having a tubular (specifically cylindrical) shape also extending in the axial direction.

Large diameter portions 13 that project radially outward are respectively formed on the two end portions in the axial direction of the outer tube 11. A locking groove 14 is recessed in the outer circumference of each large diameter portion 13. An opening edge of a through-hole 61 formed in a panel 60 of a vehicle is fitted to the locking groove 14 of each large diameter portion 13.

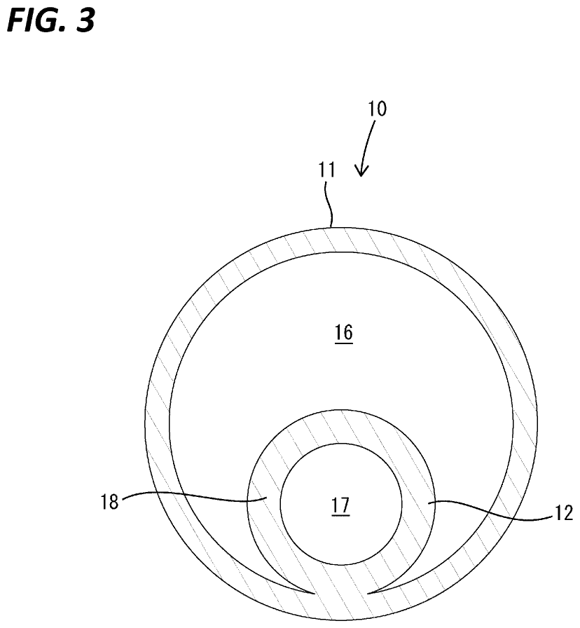

The outer tube 11 has a constant thickness in the axial direction except at the large diameter portions 13. As shown in FIG. 3, the outer tube 11 has a constant thickness in the circumferential direction. An outer circumferential surface of the outer tube 11 is a circumferential surface that is continuous with no unevenness such as stepped portions in the circumferential direction. An inner circumferential surface of the outer tube 11 is also a circumferential surface that is continuous with no unevenness such as stepped portions in the circumferential direction.

The inner diameter of the outer tube 11 is larger than the outer diameter of the inner tube 12 such that the outer tube 11 surrounds the inner tube 12. That is, the inner tube 12 is disposed inside the outer tube 11. In the present first embodiment, the outer diameter of the inner tube 12 is larger than or equal to half of the inner diameter of the outer tube 11. The length of the inner tube 12 in the axial direction is longer than the length of the outer tube 11 in the axial direction. As shown in FIG. 2, the two end portions in the axial direction of the inner tube 12 protrude in the two opposite axial directions from the opening ends of the two end portions in the axial direction of the outer tube 11.

Guiding portions 15 that expand outward are respectively formed at the two end portions in the axial direction of an inner circumferential surface of the inner tube 12. The inner tube 12 has a constant thickness in the axial direction except at the guiding portions 15. As shown in FIG. 3, the inner tube 12 has a constant thickness in the circumferential direction. The inner tube 12 is thicker than the outer tube 11 except at the guiding portions 15. An outer circumferential surface of the inner tube 12 is a circumferential surface that is continuous with no unevenness such as stepped portions in a circumferential direction. The inner circumferential surface of the inner tube 12 is also a circumferential surface that is continuous with no unevenness such as stepped portions in the circumferential direction.

The inner tube 12 and the outer tube 11 are formed in one piece as an integrally molded component. As shown in FIG. 3, a minor arc portion of the outer circumferential surface of the inner tube 12 (the lower end portion shown in the drawing) is integrally joined with a minor arc portion of the outer circumferential surface of the outer tube 11 (the lower end portion shown in the drawing).

The grommet 10 has a first path 16 formed between the inner tube 12 and the outer tube 11 and a second path 17, which is an internal space of the inner tube 12. As shown in FIG. 2, the first path 16 is formed over the entire length in the axial direction of the outer tube 11 and is open to both sides in the axial direction of the outer tube 11. The second path 17 is formed over the entire length in the axial direction of the inner tube 12 and is open to both sides in the axial direction of the inner tube 12. As shown in FIG. 3, the major arc portion of the inner tube 12 excluding the lower end portion that is joined to the outer tube 11 serves as a partition wall portion 18 that partitions the first path 16 and the second path 17 from each other.

The first path 16 that has a crescent-shaped opening shape is formed between the outer circumferential surface of the inner tube 12 and the inner circumferential surface of the outer tube 11. The second path 17 that has a circular opening shape is formed in the internal space of the inner tube 12. The cross-sectional area of the first path 16 is larger than the cross-sectional area of the second path 17.

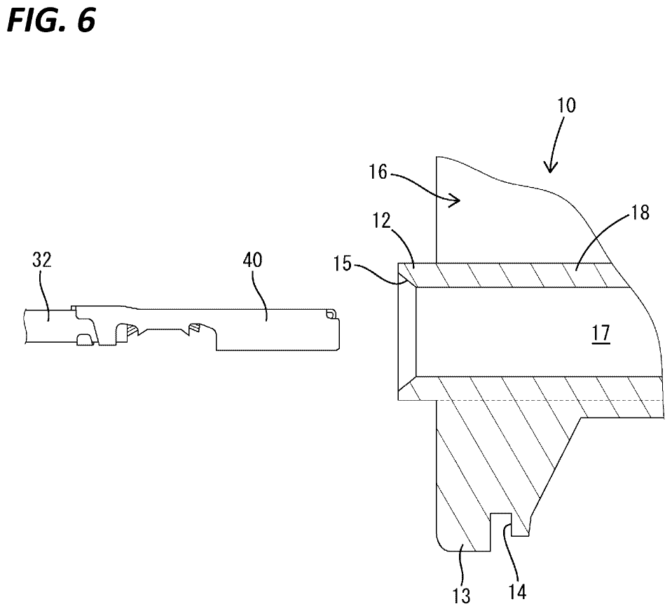

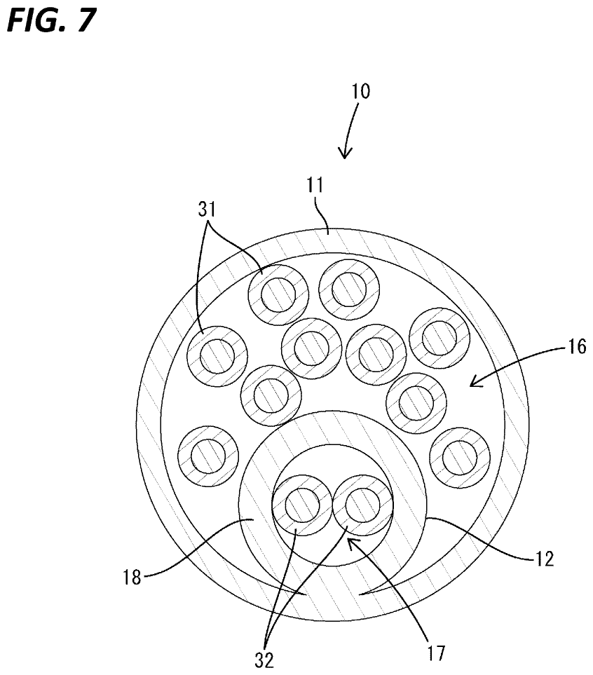

As shown in FIG. 7, a plurality of electric wires 31 and 32 are passed through and routed in the grommet 10. The plurality of first electric wires 31 of the electric wires 31 and 32 are passed through the first path 16. The leading end portions of the first electric wires 31 are crimped and connected to first terminals (not shown). The first path 16 has a size which allows a bundle of first electric wires 31 and the first terminals to be passed therethrough. The plurality of second electric wires 32 of the electric wires 31 and 32 are passed through the second path 17. As shown in FIG. 6, the leading end portions of the second electric wires 32 are crimped and connected to second terminals 40. The second path 17 has a size which allows a bundle of second electric wires 32 and the second terminals 40 to pass therethrough. The first terminals and the second terminals 40 are configured to be accommodated in the respective corresponding connectors (not shown).

The configuration of the grommet 10 is as described above, and next, the operations of the grommet 10 will be described.

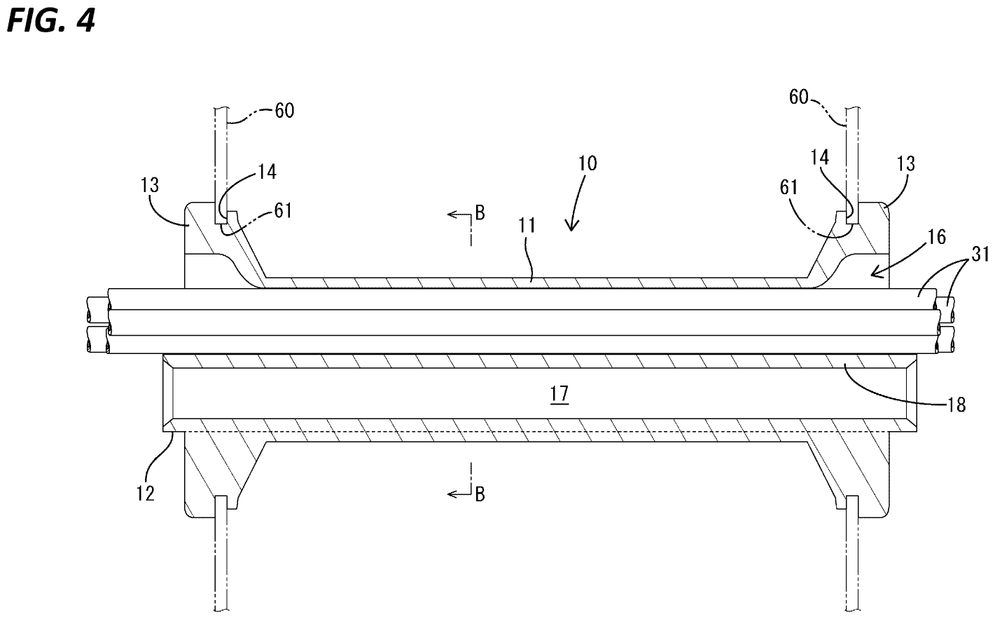

First, as shown in FIG. 4, the first electric wires 31 are inserted into the first path 16 from one end portion in the axial direction of the outer tube 11 toward the other end portion, and drawn out in the axial direction from the opening end of the other end portion. The first electric wires 31 are, for example, electric wires connected to an electric component of a standard specification, and are passed through the grommet 10 prior to the second electric wires 32. The first electric wires 31 may be passed through the first path 16 while being guided by the first terminals connected to the leading end portions.

Next, the second electric wires 32 are passed from the guiding portion 15 at the one end portion in the axial direction of the inner tube 12 through the second path 17 toward the other end portion, and drawn out in the axial direction from the opening end of the other end. The second electric wires 32 are, for example, additional electric wires connected to an optional component, and are inserted into the grommet 10 following the first electric wires 31. The second electric wires 32 can enter the second path 17 while being guided into the guiding portion 15. As shown in FIG. 6, the second electric wires 32 may be passed through the second path 17 while being guided by the second terminals 40 connected to the leading end portions.

As shown in FIG. 1, since the two end portions in the axial direction of the inner tube 12 protrude in opposite axial directions from the respective opening ends of the outer tube 11, the operator can easily recognize the two end portions in the axial direction of the inner tube 12, and can reliably insert the second electric wires 32 from the one end portion in the axial direction of the inner tube 12 into the second path 17.

The second path 17 through which the second electric wires 32 are passed and the first path 16 through which the first electric wires 31 are passed are partitioned by the partition wall portion 18 of the inner tube 12. Accordingly, contact between the second electric wires 32 with the previously passed first electric wires 31 can be avoided, making it possible to smoothly perform the task of passing the second electric wires 32 therethrough. Also, interference between the first electric wires 31 and the second terminal 40 can be easily avoided, making it possible to prevent damage to the first electric wires 31 by the second terminal 40. Further, since the inner tube 12 is formed within such a range as to be accommodated inside the outside tube 11, the grommet 10 is not unnecessarily increased in size. Further, the external appearance similar to that of an existing grommet can be maintained.

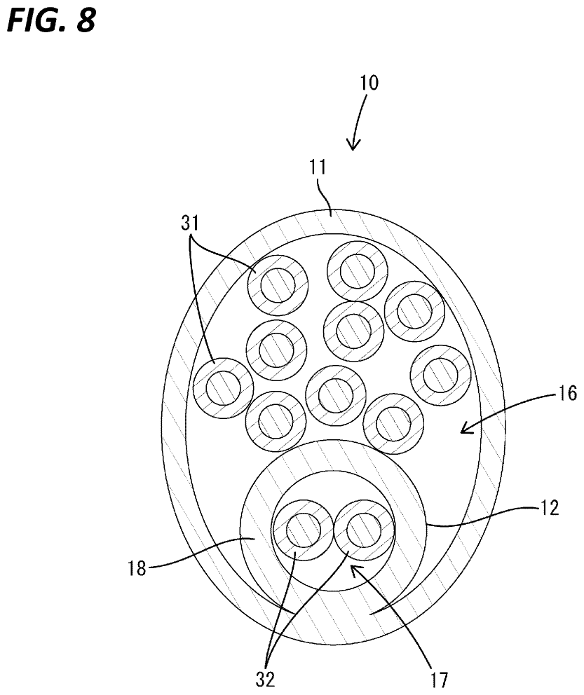

For example, when the panel 60 is a door panel that is openable and closable via a hinge, the grommet 10 deforms following the opening and closing of the panel 60, and the inner tube 12 and the outer tube 11 bend. In the present first embodiment, both the inner tube 12 and the outer tube 11 have a cylindrical shape. For this reason, the inner tube 12 and the outer tube 11 can flexibly deform according to an external force such as a bending force. For example, as shown in FIG. 8, the inner tube 12 and the outer tube 11 can deform so as to stretch in the up-down direction by being bent and compressed leftward or rightward.

Also, in the present first embodiment, the inner tube 12 is thicker than the outer tube 11, and the inner tube 12 has a rigidity according to which the hollow shape of the second path 17 is maintained. For this reason, even when the inner tube 12 deforms, the deforming amount of the inner tube 12 can be kept lower than the deforming amount of the outer tube 11, and the space through which the second electric wires 32 are passed can be ensured in the second path 17.

Further, since the inner circumferential surface of the outer tube 11, the outer circumferential surface of the inner tube 12, and the inner circumferential surface of the inner tube 12 are continuous in the circumferential direction with no stepped portion, the first path 16 and the second path 17 can be efficiently ensured in the grommet 10 in a space-efficient manner.

### Second Embodiment

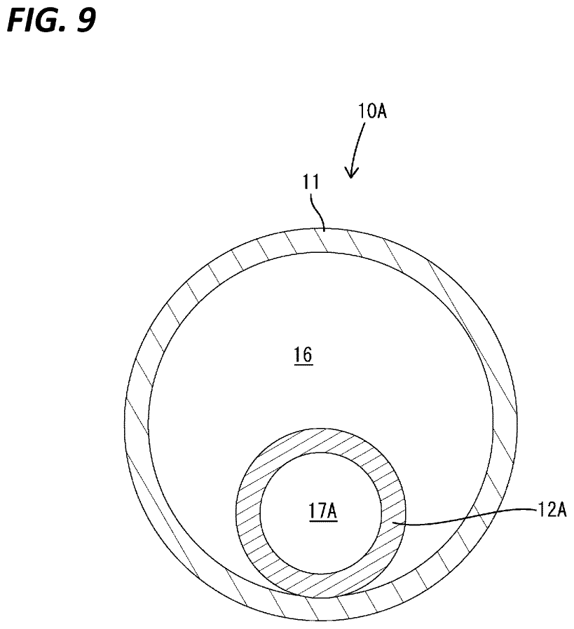

A second embodiment of the present disclosure is shown in FIG. 9. In a grommet 10A according to the present second embodiment, an inner tube 12A is formed of a material different from that of the outer tube 11, and formed integrally with the outer tube 11 through two-color molding.

Specifically, the inner tube 12A is formed of a material such as a flexibly deformable hard synthetic rubber, for example, that is harder than that of the outer tube 11. For example, the grommet 10A is formed by forming the inner tube 12A through primary molding using a hard material, then forming the outer tube 11 through secondary molding using a material softer than that of the inner tube 12A. Since the inner tube 12A is formed of a hard material, the inner tube 12A can have a rigidity according to which the hollow shape of the second path 17A can be maintained even if the thickness of the inner tube 12A is less than or equal to the thickness of the outer tube 11. Other configurations such as a lower end portion of the outer circumferential surface of the inner tube 12A and a lower end portion of the inner circumferential surface of the outer tube 11 being joined to each other are the same as in the first embodiment.

According to the second embodiment, the rigidity of the inner tube 12A can be higher than that of the outer tube 11, making it possible to improve the degree of freedom in design.

### Third Embodiment

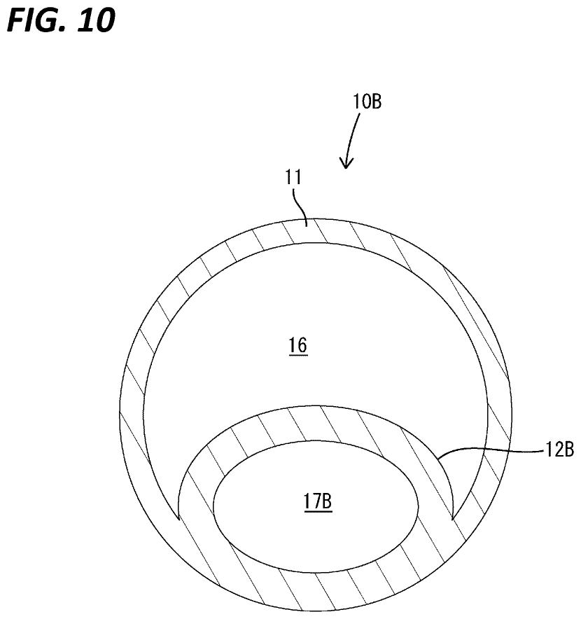

A third embodiment of the present disclosure is shown in FIG. 10. In a grommet 10B according to the third embodiment, a cross-section of an inner tube 12B has an oval shape elongated in the left-right direction.

A second path 17B, which is an internal space of the inner tube 12B, is expanded in the left-right direction farther than the second path 17 of the first embodiment. A lower end portion of the inner tube 12B is joined integrally with the lower end portion of the outer tube 11 and absorbed in the thickness of the lower end portion of the outer tube 11. Other configurations are similar to the first embodiment.

According to the third embodiment, a wide space through which the second electric wires 32 are passed can be ensured in the second path 17B.

### Other Embodiments of the Present Disclosure

The embodiments disclosed here are to be considered in all respects as illustrative and not limiting.

In the first to third embodiments, both the inner tube and the outer tube extend straight in the axial direction. However, according to another embodiment, a configuration is also possible in which at least one of the inner tube and the outer tube includes a portion that has a stretchable bellows portion and is formed in a recessed and protruding shape in the axial direction.

In the first to third embodiments, the first electric wires are first passed through the first path, and then the second electric wires are additionally passed through the second path. However, according to another embodiment, a configuration is also possible in which the second electric wires are first passed through the second path and then the first electric wires are additionally passed through the first path. Also, for example, in the case where only components of a standard specification are used without using optional components, a configuration is also possible in which the grommet is used with no second electric wire inserted into the second path.

In the first to third embodiments, both the inner tube and the outer tube are formed in a cylindrical shape. However, according to another embodiment, a configuration is also possible in which at least one of the inner tube and the outer tube is formed in an angular tubular shape having a cross-section formed in a polygonal shape such as a rectangle.

In the first to third embodiments, the outer circumferential surface of the inner tube and the inner circumferential surface of the outer tube are integrally joined. However, according to another embodiment, a configuration is also possible in which the inner tube is supported in the air so as to be spaced apart from the inner circumferential surface of the outer tube.

In the first embodiment, the large diameter portions are respectively formed at the two end portions in the axial direction of the outer tube. However, according to another embodiment, a configuration is also possible in which a single large diameter portion is formed at an intermediate portion in the axial direction of the outer tube. Alternatively, the outer tube need not have a large diameter portion.

In the first embodiment, both end portions in the axial direction of the inner tube protrude from the opening end of the outer tube in the axial direction. However, according to another embodiment, a configuration is also possible in which only one end portion of the two end portions in the axial direction of the inner tube protrudes in the axial direction from the opening end of the outer tube. Alternatively, a configuration is also possible in which neither of the end portions in the axial direction of the inner tube protrude from the opening ends of the outer tube.

In the first embodiment, the plurality of first electric wires are passed through the first path and the plurality of second electric wires are passed through the second path. However, according to another embodiment, a configuration is also possible in which one first electric wire is passed through the first path and one second electric wire is passed through the second path.

In the second embodiment, the inner tube and the outer tube are integrally joined through two-color molding. However, according to another embodiment, a configuration is also possible in which the inner tube and the outer tube are formed separately in advance and are integrally joined by a joining means such as an adhesive.

### LIST OF REFERENCE NUMERALS

10, 10A, 10B Grommet
11 Outer tube
12, 12A, 12B Inner tube
13 Large diameter portion
14 Locking groove
15 Guiding portion
16 First path
17, 17A, 17B Second path
18 Partition wall portion
31 First electric wire (electric wire)
32 Second electric wire (electric wire)
40 Second terminal
60 Panel
61 Through hole

1. A grommet through which an electric wire can be passed, comprising:
a tubular inner tube; and
a tubular outer tube provided around the inner tube so as to surround the inner tube,
wherein a space between the inner tube and the outer tube forms a first path through which a first electric wire of the electric wire can be passed,
an internal space of the inner tube forms a second path through which a second wire of the electric wire can be passed, and
the inner tube is formed over the entire length in an axial direction of the grommet.

2. The grommet according to claim 1,
wherein the inner tube is in contact with and integrally joined to an inner circumferential surface of the outer tube.

3. The grommet according to claim 1,
wherein the inner tube is formed in a cylindrical shape.

4. The grommet according to claim 3,
wherein the outer tube is formed in a cylindrical shape, and
a minor arc portion of an outer circumferential surface of the inner tube and a minor arc portion of an inner circumferential surface of the outer tube are integrally joined to each other.

5. The grommet according to claim 1,
wherein the outer circumferential surface of the inner tube and the inner circumferential surface of the outer tube are formed continuously without a stepped portion in a circumferential direction.

6. The grommet according to claim 1,
wherein the inner tube has rigidity according to which a hollow shape of the second path can be maintained.

7. The grommet according to claim 1,
wherein at least one end portion of two end portions in an axial direction of the inner tube protrudes in the axial direction from an opening end of the outer tube.

8. The grommet according to claim 1,
wherein the first path has a size that allows a plurality of the first electric wires to be passed through the first path.

9. The grommet according to claim 1,
wherein the second path has a size that allows a plurality of the second electric wires to be passed through the second path.

10. The grommet according to claim 7,
wherein the two end portions in the axial direction of the inner tube protrude in the axial direction from the opening ends of the two end portions in the axial direction of the outer tube.

11. The grommet according to claim 1,
wherein guiding portions that expand outward are respectively formed at the two end portions in the axial direction of an inner circumferential surface of the inner tube.

12. The grommet according to claim 11,
wherein the inner tube is thicker than the outer tube except at the guiding portions.
